(19) United States
(12) Patent Application Publication
(10) Pub. No.: US 2008/0056334 A1
(43) Pub. Date: Mar. 6, 2008

(54) APPARATUS AND METHOD FOR CONTROLLING DATA RATE IN A COMMUNICATION SYSTEM USING MULTI-HOP SCHEME

(75) Inventors: Kyung-Joo Suh, Seoul (KR); Jung-Won Kim, Seoul (KR); Dae-Gyun Kim, Seongnam-si (KR); Hyon-Goo Kang, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/850,532

(22) Filed: Sep. 5, 2007

(30) Foreign Application Priority Data
Sep. 5, 2006 (KR) 85364-2006

(51) Int. Cl. H04Q 7/20

(52) U.S. Cl. 375/132; 455/453; 375/E01.033

(57) ABSTRACT

A method for controlling a data rate by a Base Station (BS) in a multi-hop communication system in which a Relay Station (RS) located between the BS and a Mobile Station (MS) relays a signal exchanged between the BS and the MS. The data rate control method includes receiving, from the RS, channel information of the MS and channel information of the RS; calculating a target data rate to the RS using the channel information of the MS and the channel information of the RS; generating data to be transmitted to the RS according to the calculated target data rate; and transmitting the generated data to the RS.

### PRIORITY

This application claims priority under 35 U.S.C. § 119(a) to a Korean Patent Application filed in the Korean Intellectual Property Office on Sep. 5, 2006 and assigned Serial No. 2006-85364, the disclosure of which is incorporated herein by reference.

### BACKGROUND OF THE INVENTION

1. Field of the Invention

The present invention relates generally to a communication system, and in particular, to an apparatus and method for controlling a data rate in a communication system using Multi-Hop.

2. Description of the Related Art

Generally, a communication system using Multi-Hop (‘multi-hop communication system’) has been proposed to increase terminal throughput and increase system capacity.

In the multi-hop communication system, when a channel condition between a Base Station (BS) and a Mobile Station (MS) is poor, a Relay Station (RS) located between the BS and the MS relays the signal exchanged between the BS and the MS. As a result, the MS can receive a wireless channel having a good channel condition, thereby increasing the terminal throughput and thus contributing to the increase in the system capacity.

Extensive research into the multi-hop communication system is being conducted to support a data rate greater than the data rate available for data transmission, and to extend the available coverage. In addition, extensive research into the multi-hop communication system is being carried out to address the problem that the data rate and the coverage area are limited due to the high path loss in the IEEE 802.16 communication system or the 4^{th} generation mobile communication system that operates in a high-frequency band. The multi-hop communication system relays data by means of an RS to reduce the path loss, thereby enabling high-speed data communication, and to transfer a signal even to the MS located far from the BS, thereby extending the coverage area.

In the conventional single-hop communication system, because wireless data communication occurs only between the BS and the MS, the BS can perform communication within one frame when it transmits or receives data to/from the MS. Therefore, the BS calculates a data rate of the MS using an MS Channel Quality Index (CQI) report value of a previous frame, allocates wireless resources to be used for the next frame according to the calculated data rate, and determines a Modulation Coding Scheme (MCS) level according to the calculated data rate. The ‘MCS level’ as used herein indicates information on a modulation scheme and a coding scheme used in the current data transmission. However, in the multi-hop communication system, because there are several wireless sections (or intervals), there is a need for a scheme for calculating a data rate of each wireless section and performing resource allocation and MCS level decision for each wireless section.

FIG. 1 illustrates a configuration of a general multi-hop (or 2-hop) communication system.

Shown in FIG. 1 is a communication system that extends the coverage area using a multi-hop scheme in order to solve the narrow-coverage area problem of the conventional single-hop communication system.

An RS 130 is located between a BS 120 and an MS 140 to service the MS 140 located far from the BS 120, and relays the data transmitted by the BS 120 to the MS 140, thereby reducing a path loss. In this case, because the MS 140 cannot directly communicate with the BS 120 due to the limited transmission power, the MS 140 should exchange data with the BS 120 via the RS 130.

In the multi-hop communication system of the 2-hop type, after the BS 120 previously transmits control information and data to the RS 130, the RS 130 should relay the received information to the MS 140. Therefore, the communication between the BS 120 and the RS 130 should be isolated from the communication between the RS 130 and the MS 140.

To support the relay, the multi-hop communication system can employ one of a scheme for defining sub-frames in one frame to isolate the communication section between the BS 120 and the RS 130 from the communication section between the RS 130 and the MS 140, and another scheme for generating two frames and using different frames for the communication between the BS 120 and the RS 130 and the communication between the RS 130 and the MS 140.

Because the MCS level and the allocated resources used when the RS 130 services the MS 140 are determined depending on CQI information before 3 frames, the data exchange between the RS 130 and the MS 140 may decrease in the efficiency and suffer from frequent transmission failure. In this case, 2 frames are used when the BS 120 receives the CQI information from the MS 140, and 1 frame is used when the BS 120 provides the MCS information and the resource allocation information to the RS 130. An ACK/NACK message used for informing the BS 120 of transmission success/failure between the RS 130 and the MS should also pass through 2 hops to be normally transmitted, the BS 120 having no information on the success/failure in the previous data transmission/reception may transmit the data to be transmitted in the next frame to the RS 130. In this situation, the data may be continuously and undesirably buffered in the RS 130.

When the RS 130 continuously buffers the data, the MSs receiving a service from the RS 130 may suffer from additional delay and jitter due to a change in the queue length of the RS 130.

When the BS 120 simply forwards data to the MS 140, the RS 130 should buffer all data of MSs located in its service coverage area. In this case, if the MS 140 performs handover from a serving RS to a target RS, the data previously transmitted to the serving RS is useless, and the BS 120 must re-transmit the data to the target RS, thereby causing a decrease in the entire system performance, a waste of resources, and an increase in the reception delay of the MS.

### SUMMARY OF THE INVENTION

An aspect of the present invention is to address at least the problems and/or disadvantages and to provide at least the advantages described below. Accordingly, an aspect of the present invention is to provide an apparatus and method for controlling a data rate between a BS and an RS taking into account data exchange between the BS and an MS, and data exchange between the BS and the RS in a multi-hop communication system.

Another aspect of the present invention is to provide an apparatus and method for controlling a data rate between a BS and an RS using channel information between the BS and an MS, and channel information between the BS and the RS in a multi-hop communication system.

Another aspect of the present invention is to provide a data rate control apparatus and method for solving the problem that as an ACK/NACK message should also pass through 2 hops to be normally transmitted, a BS having no information on the success/failure in the previous data transmission/reception transmits data to be transmitted in the next frame to an RS and the data is continuously buffered in the RS, in a multi-hop communication system.

Another aspect of the present invention is to provide a data rate control apparatus and method for solving the problem that when an MS performs handover from a serving RS to a target RS, the data previously transmitted by a BS to the serving RS is useless and the BS must re-transmit the data to the target RS, thereby causing a decrease in the entire system performance in a multi-hop communication system.

According to one aspect of the present invention, there is provided a method for controlling a data rate by a Base Station (BS) in a multi-hop communication system in which a Relay Station (RS) located between the BS and a Mobile Station (MS) relays a signal exchanged between the BS and the MS. The data rate control method includes receiving, from the RS, channel information of the MS and channel information of the RS; calculating a target data rate to the RS using the channel information of the MS and the channel information of the RS; generating data to be transmitted to the RS according to the calculated target data rate; and transmitting the generated data to the RS.

According to another aspect of the present invention, there is provided an apparatus for controlling a data rate in a Base Station (BS) of a multi-hop communication system in which a Relay Station (RS) located between the BS and a Mobile Station (MS) relays a signal exchanged between the BS and the MS. The data rate control apparatus includes a channel information receiver for receiving, from the RS, channel information of the MS and channel information of the RS; a data rate controller for calculating a target data rate to the RS using the channel information of the MS and the channel information of the RS; an adaptive encoder for generating data to be transmitted to the RS according to the calculated target data rate; and a transmitter for transmitting the generated data to the RS.

According to further another aspect of the present invention, there is provided a method for controlling a data rate by a Relay Station (RS) in a multi-hop communication system in which the RS located between a Base Station (BS) and a Mobile Station (MS) relays a signal exchanged between the BS and the MS. The data rate control method includes determining if channel information is received from at least one of MSs; and upon receipt of the channel information from the MS, relaying the channel information of the MS to the BS, and reporting its own channel information to the BS.

According to yet another aspect of the present invention, there is provided an apparatus for controlling a data rate in a Relay Station (RS) of a multi-hop communication system in which the RS located between a Base Station (BS) and a Mobile Station (MS) relays a signal exchanged between the BS and the MS. The data rate control apparatus includes a channel information receiver for receiving channel information from at least one of MSs; a signal receiver for receiving data from the BS; an adaptive encoder for generating data to be transmitted to the MSs; a physical layer data transmitter for transmitting the generated data to the MSs; a queue length calculator for calculating a queue length based on an amount of data to be transmitted to the MSs; and a feedback information transmission unit for transmitting, to the BS, channel information of the RS, channel information of the MSs, and the calculated queue length information.

### BRIEF DESCRIPTION OF THE DRAWINGS

The above and other aspects, features and advantages of the present invention will become more apparent from the following detailed description when taken in conjunction with the accompanying drawings in which:

FIG. 1 illustrates a configuration of a general multi-hop (or 2-hop) communication system;

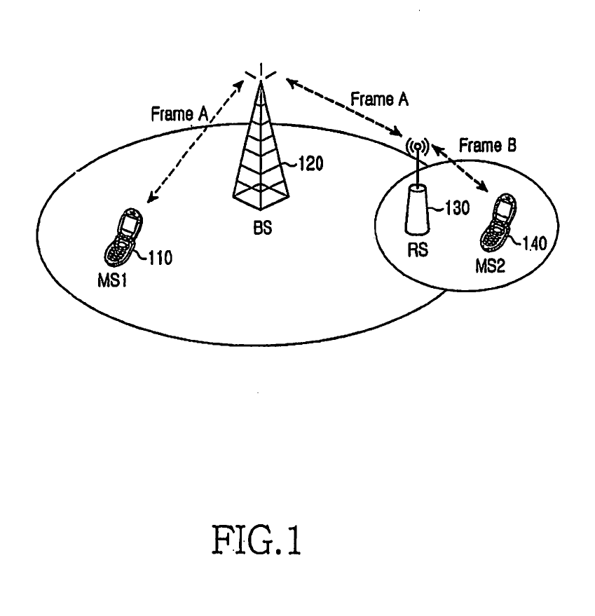

FIG. 2 illustrates a method for controlling a data rate in a multi-hop communication system according to an embodiment of the present invention;

FIG. 3 illustrates a BS's data transmission operation of controlling a data rate in a multi-hop communication system according to an embodiment of the present invention;

FIG. 4 illustrates a data transmission operation of an RS in a multi-hop communication system according to an embodiment of the present invention;

FIG. 5 illustrates a structure of a BS apparatus in a multi-hop communication system according to an embodiment of the present invention;

FIG. 6 illustrates a structure of an RS apparatus in a multi-hop communication system according to an embodiment of the present invention; and

FIG. 7 illustrates a method for calculating a data rate by a BS in a multi-hop communication system according to an embodiment of the present invention.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for clarity and conciseness.

Although the present invention can be applied to both of the above-stated frame structures, a description of the present invention will be made based on the scheme of using separate frames for communicating between a BS and an RS, and communicating between the RS and an MS. becA description of the present invention will be made based on the scheme of using a frame A for communicating between the BS and the RS, and a frame B for communicating between the RS and the MS. The following advantages are realized by the present invention.

First, because the BS and the RS can perform simultaneous operation, resource reuse is possible.

Second, the BS can allocate only the necessary requested resources, enabling efficient use of the resources.

Third, the RS and the MS use the same resource request/allocation scheme, contributing to a decrease in the complexity.

Fourth, the data exchange scheme between the MS and the RS is equal to the data exchange scheme between the MS and the BS, contributing to a decrease in the overall complexity of the system.

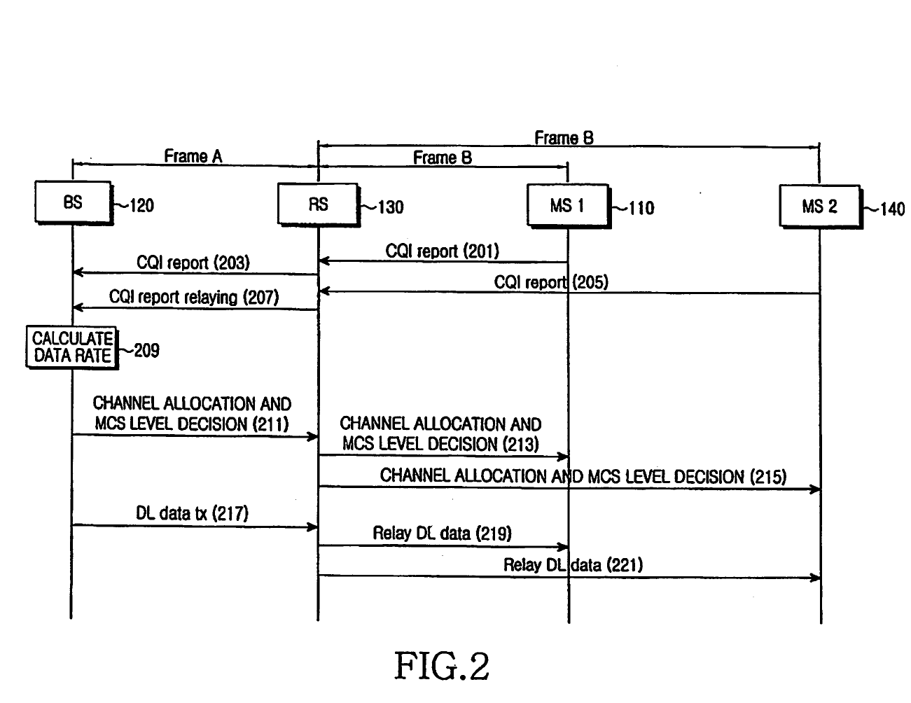

FIG. 2 illustrates a method for controlling a data rate in a multi-hop communication system according to an embodiment of the present invention. With reference to FIG. 2, a description will now be made of an operation of transmitting/receiving information necessary for channel-based data rate control.

It is assumed in FIG. 2 that MSs managed by an RS 130 include an MS1 110 and an MS2 140.

In steps 201 and 205, the MS1 110 and the MS2 140 feed back CQI information to the RS 130 based on signal strength (e.g. pilot signal strength) of a pilot channel transmitted from the RS 130.

In step 203, the RS 130 measures the pilot signal strength of a BS 120 and then feeds back CQI information to the BS 120. Here, step 203 can be performed either before or after each of steps 201 and 205.

After steps 201 and 205, in step 207 the RS 130 relays to the BS 120 the CQI information received from the MS 110 and the MS2 140. In this case, the RS 130 relays to the BS 120 the intact CQI information received from the MS1 110 and the MS2 140.

In step 209, the BS 120 determines the channel capacities of the MSs based on the CQI information from the MS1 110 and the MS2 140, and calculates a target data rate for each of the individual MSs. Further, in step 209, the BS 120 calculates a data rate to the RS 130 based on the CQI information of the RS 130. When the data rate between the BS 120 and the RS 130 is calculated by means of the scheme proposed by the present invention, the RS 130 can stably buffer the data to be transmitted in the next frame, and can remove the jitter occurring due to the abrupt change in the queue length. In addition, the BS 120 previously transmits to the RS 130 only as much data as can be handled by the capacity of the RS 130, thereby reducing the waste of the transmission frames between the BS 120 and the RS 130. As a result, when the MS2 140 performs handover to a target RS, it is possible to minimize the amount of data that the existing RS 130 should discard.

In step 211, the BS 120 performs channel allocation and MCS level decision with the RS 130, and provides the resulting information to the RS 130. Thereafter, in step 213, the RS 130 performs channel allocation and MCS level decision with the MS1 110, and provides the resulting information to the MS1 110. Before, other or at the same time as step 213, the RS 130 performs in step 215 channel allocation and MCS level decision with the MS2 140, and provides the resulting information to the MS2 140.

After the channel allocation and MCS level decision is completed, in step 217 the BS 120 transmits data to the RS 130 over the allocated resource. In steps 219 and 221, the RS 130 relays the data received from the BS 120 to the MS1 110 and the MS2 140.

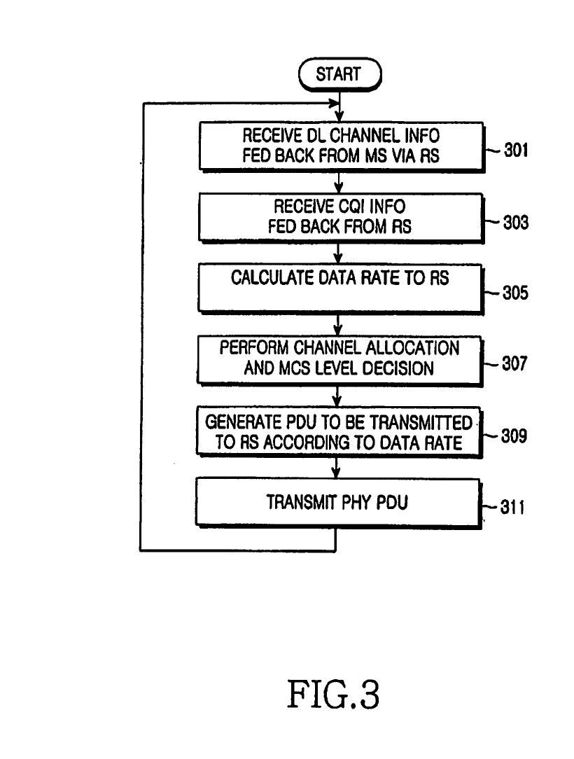

FIG. 3 illustrates a data transmission operation of a BS for controlling a data rate in a multi-hop communication system according to an embodiment of the present invention.

In step 301, a BS 120 receives downlink channel information fed back from the MSs via an RS 130. The downlink channel information from the MSs includes the CQI information of the MSs.

In step 303, the BS 120 receives the CQI information of the RS 130, fed back from the RS 130. Steps 301 and 303 are interchangeable.

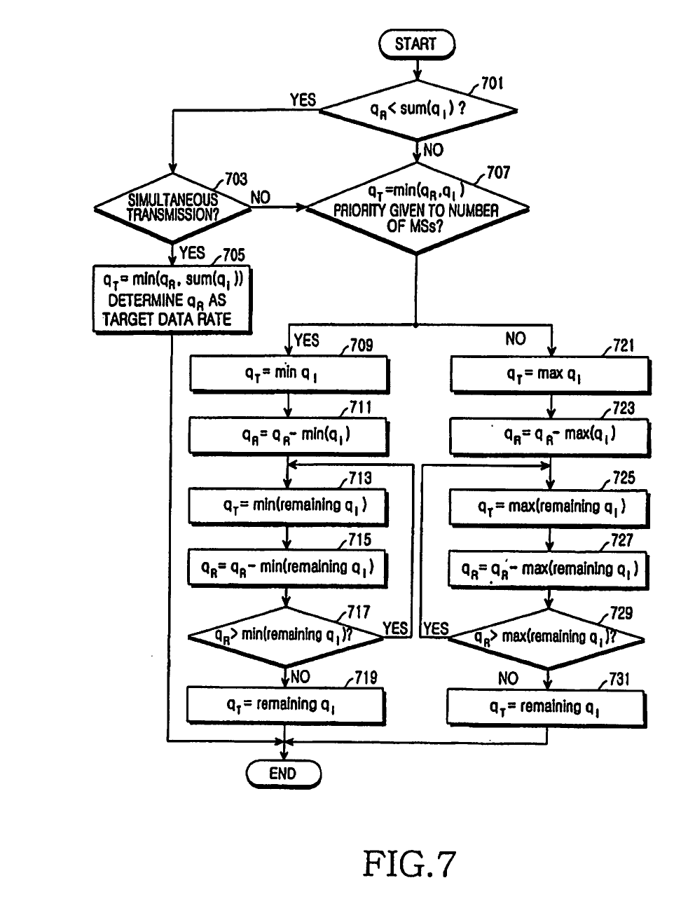

Thereafter, in step 305 , the BS 120 calculates a data rate through the process described below in FIG. 7, using the CQI information of the MSs and the CQI information of the RS 130, both of which indicate the amount of data that the MSs and the RS 130 should previously transmit to the RS 130.

In step 307, the BS 120 performs a channel allocation and a MCS level decision based on the calculated data rate.

Thereafter, in step 309, the BS 120 generates a Packet Data Unit (PDU) that the BS 120 will transmit to the RS 130 according to the calculated data rate. In step 311, the BS 120 transmits the PDU to the RS 130.

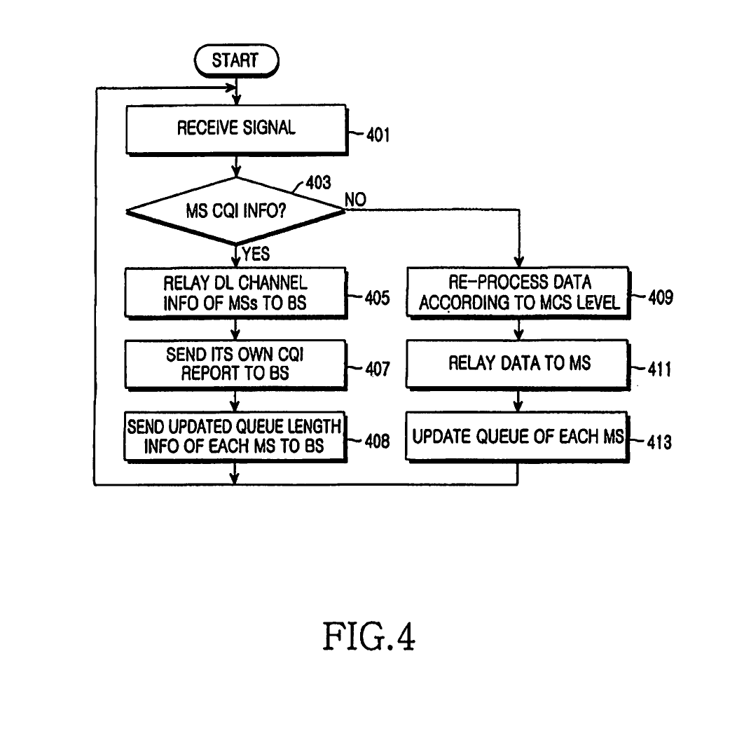

FIG. 4 illustrates a data transmission operation of an RS in a multi-hop communication system according to an embodiment of the present invention.

In step 401, an RS 130 receives a signal. In step 403, the RS 130 determines if the received signal is CQI information of an MS, to be fed back to a BS 120. That is, the RS 130 determines if the received signal is CQI information transmitted from MSs. In this case, the RS 130 determines if the received signal is an uplink signal or a downlink signal. If the received signal is an uplink signal, the RS 130 performs an operation of steps 405 to 408. However, if the received signal is a downlink signal, the RS 130 performs an operation of steps 409 to 413.

If the received signal is the CQI information transmitted from the MSs, the RS 130 relays the downlink channel information of the MSs to the BS 120 in step 405. The downlink channel information of the MSs includes the CQI information, and the RS 130 re-transmits the channel information of the MSs to the BS 120.

After step 405, the RS 130 reports its own CQI information to the BS 120 in step 407. Thereafter, in step 408, the RS 130 reports the updated queue length for each of the individual MSs to the BS 120, and then returns to step 401.

However, if it is determined in step 403 that the received signal is not CQI information of an MS 140, i.e. the received signal is a signal received from the BS 120, or if the signal that the RS 130 has received from the BS 120 is information on a transmission channel and an MCS level, the RS 130 re-processes in step 409 the data according to the MCS level determined by the BS 120.

Thereafter, in step 411, the RS 130 relays the re-processed data to the MS 140. In step 413, the RS 130 calculates its own queue length according to the amount of data to be transmitted to the MS 140, and reports the calculated queue length to the BS 120.

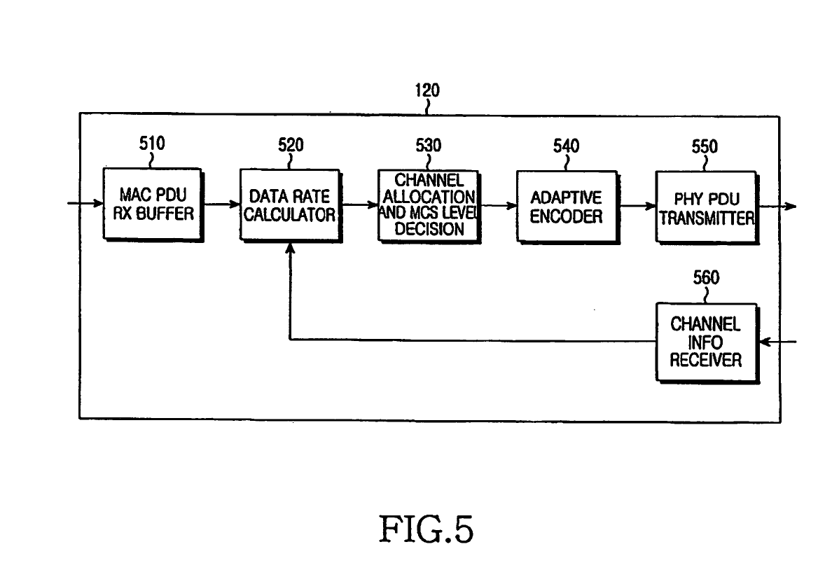

FIG. 5 illustrates a structure of a BS apparatus in a multi-hop communication system according to an embodiment of the present invention.

A BS 120 includes a Media Access Control (MAC) PDU reception buffer 510, a channel information receiver 560, a data rate controller 520, a channel allocation and MCS level decision unit 530, an adaptive encoder 540, and a PHYsical (PHY) PDU transmitter 550.

The MAC PDU reception buffer 510 receives a MAC PDU from an upper layer. The upper layer herein can be a Media Access Control (MAC) layer. The channel information receiver 560 receives channel information from the RS 130. The data rate controller 520 calculates data rate using CQI information of MSs and CQI information of the RS 130, received to determine a data rate between the BS 120 and the RS 130. The channel allocation and MCS level decision unit 530 performs channel allocation and MCS level decision according to the calculated data rate. The adaptive encoder 540 processes data based on the determined MCS level and the channel allocation information. The PHY PDU transmitter 550 transmits the data processed by the adaptive encoder 540 to the RS 130.

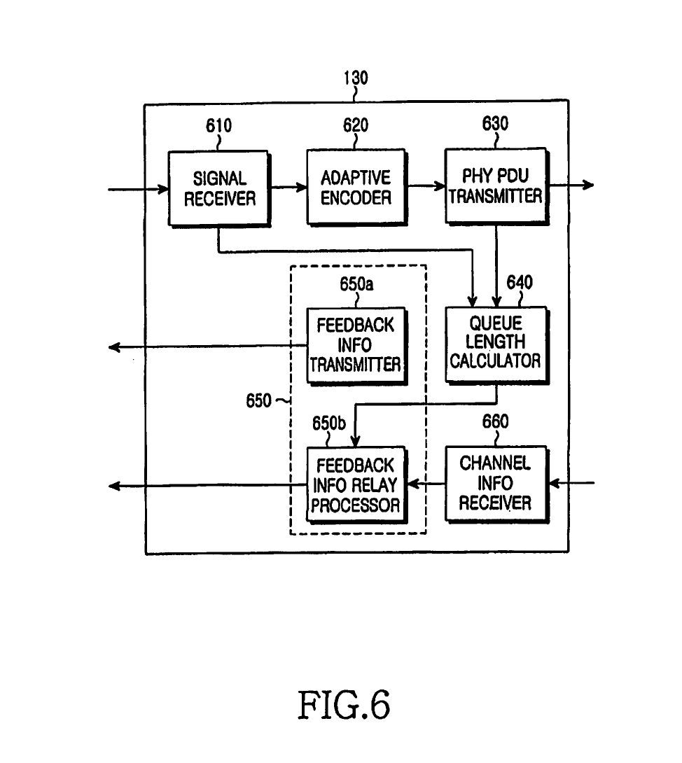

FIG. 6 illustrates a structure of an RS apparatus in a multi-hop communication system according to an embodiment of the present invention.

An RS 130 includes a signal receiver 610, an adaptive encoder 620, a PHY PDU transmitter 630, a queue length calculator 640, a feedback information transmission unit 650, and a channel information receiver 660.

The signal receiver 610 receives a signal transmitted by the BS 120, and outputs the received signal to the adaptive encoder 620. In addition, the signal receiver 610 provides the queue length calculator 640 with information on the amount of data, acquired from the signal transmitted from the BS 120. The adaptive encoder 620 re-processes the signal received from the signal receiver 610, for each of the MSs, and outputs the re-processed signal in the form of data. The PHY PDU transmitter 630 transmits to an MS 140 the data processed by the adaptive encoder 620. The PHY PDU transmitter 630 transmits data from the RS 130 to the MS 140, and then provides to the queue length calculator 640 information on the amount of data transmitted to the MS 140. The queue length calculator 640 calculates a queue length based on the account of the data received from the BS 120 and the amount of data transmitted from the PHY PDU transmitter 630 to the MS 140. The channel information receiver 660 receives the channel information transmitted from the MSs. The feedback information transmission unit 650 relays the CQI information transmitted from the MSs to the BS 120, or transmits the CQI information of the RS 130 to the BS 120.

The feedback information transmission unit 650 includes a feedback information relaying processor 650b, and a feedback information transmitter 650a. The feedback information relaying processor 650b relays to the BS 120 the channel information received from the MS or its sub RS via the channel information receiver 660, and relays to the BS 120 the queue length information calculated by the queue length calculator 640. The feedback information transmitter 650a transmits to the BS 120 the CQI information of the RS 130.

FIG. 7 illustrates a method for calculating a data rate by a BS in a multi-hop communication system according to an embodiment of the present invention.

If Cᵢ(t) is defined as a channel capacity at a time t, i.e. Cᵢ(t) (Cᵢ=BWlog₂(1+SINRᵢ)bit/sec) is defined as a channel capacity between an RS 130 and an i^{th} MS, E[Cᵢ(t)] is an average channel capacity between the RS 130 and the i^{th} MS. Because E[Cᵢ(t)] is given in bit/sec, the average number of bits transmitted in one frame is a product of E[Cᵢ(t)] and a frame length T.

A target data rate can be expressed as Equation (1). The target data rate is a target data rate at which the BS 120 transmits data to the RS 130 taking the MS 140 into consideration.
q_{T}=E[Cᵢ(t)]×T, where T is a frame length (1)
where q_{T} denotes a target data rate (bits/sec).

As shown Equation (2), for the case where there are an RS 130 and multiple MSs belonging to the RS 130, the BS 120 takes the minimum value between the channel capacity available for data transmission to the RS and the channel capacity available for data transmission to each of the MSs, and determines the minimum value as a data rate.
q_{Ti}=min(E[C_{R}(t)]×T_{R},E[Cᵢ(t)]×Tᵢ) (2)

When there are several MSs observed by the RS 130, the BS 120 takes as the target data rate the minimum value between a sum of qᵢ values and a q_{R} value as shown in Equation (3). Herein, q, denotes a data rate of each individual MS belonging to the RS, and q_{R} denotes a data rate for the RS.
q_{Ti}=min(E[C_{R}(t)]×T_{R},ΣE[Cᵢ(t)]×Tᵢ) (3)

In Equation (4), when the channel situation to the RS is a simultaneous transmission to the MSs as shown in FIG. 7, the BS selects the particular MSs depending on a certain selection criterion because of the low channel capacity, and performs step 709 and its succeeding steps, or step 721 and its succeeding steps according to whether or not the BS transmits data to the RS 130 for the MSs.
q_{R}<Σqᵢ
i.e., E[C_{R}(t)]×T_{R}<ΣE[Cᵢ(t)]×Tᵢ (4)
where Σqᵢ denotes a sum of data rates for individual MSs belonging to the RS.

Steps 721 to 731 correspond to a data rate decision method based on a criterion for maximizing the resource efficiency, and steps 709 to 719 correspond to a method for maximizing the number of MSs simultaneously supported by the RS 130.

In step 701, the BS 120 determines if q_{R} is less than Σqᵢ. If q_{R} is less than Σqᵢ, the BS determines in step 703 if there is a simultaneous transmission at qᵢ. In the case of a simultaneous transmission, the BS takes the minimum value between q_{R} and Σqᵢ to find q_{T} in step 705. As a result, the q_{R} value is determined as a target data rate. This means that the data rate to the RS is preferentially restricted to the channel capacity. However, in the case of non-simultaneous transmission, the BS proceeds to step 707.

However, if q_{R} is greater than or equal to Σqᵢ in step 701, the BS selects as q_{T} the minimum value between q_{R} and qᵢ in step 707. When the BS selects qᵢ, it is important to determine which q, the base station will preferentially select. For example, the BS takes the number of MSs into account when the BS selects a qᵢ having the small account of data, and the BS takes the resource efficiency into account when the BS selects a qᵢ having a large amount of data. The process is slightly different according to whether the selection criterion is the resource efficiency or the number of supportable MSs.

Therefore, the BS 120 determines in step 707 if priority is given to the number of MSs.

If priority is given to the number of MSs, the BS 120 sets a target data rate q_{R} to the minimum value among qᵢ in step 709. Thereafter, in step 711, the BS updates q_{R} with a value obtained by subtracting, from q_{R}, the minimum value among the q, values, or the q_{T} value found in step 709. In step 713, the BS takes as q_{T} the minimum value among the remaining qᵢ. In step 715, the BS updates q_{R}, with a value obtained by subtracting, from q_{R}, the minimum value among the remaining qᵢ, or the q_{T} value found in step 713. This process is repeated while it is determined in step 717 that the minimum value among the remaining qᵢ, or the minimum value among the remaining q, after finding the q_{T} in step 713, is less than the q_{R} updated in step 715. However, if the minimum value among the remaining q, after finding the q_{T} is greater than or equal to the q_{R} updated in step 715, in step 719 the BS updates the target data rate q_{T} with the remaining qᵢ value.

The found q_{T} value is a target data rate for the case where data is transmitted according to the priority given to the number of MSs. The BS finds a sum, sum(q_{T}), of the q_{T} values found according to the priority, and determines sum(q_{T}) as a target data rate between the BS and the RS. That is, when the BS simultaneously transmits data to some MSs, the data rate is sum(q_{T}).

However, if it is determined in step 707 that priority is not given to the number of MSs, i.e. priority is given to the resource efficiency, in step 721 the BS sets q_{T} to the maximum qᵢ among qᵢ.

In step 723, the BS updates a value of the q_{R} with a value obtained by subtracting, from q_{R}, the maximum qᵢ, or the qᵢ value found in step 721. Thereafter, in step 725, the BS takes as q_{T} the maximum value among the remaining qᵢ. In step 727, the BS sets q_{R} to a value obtained by subtracting, from q_{R}, the maximum value among the remaining qᵢ, or the q_{T} value found in step 725. This process is repeated while it is determined in step 729 that the maximum value among the remaining qᵢ, or the maximum value among the remaining q, after finding the maximum value in step 725, is less than the updated q_{R} value, or the q_{R} value found in step 727.

However, when the maximum value among the remaining qᵢ after finding the q_{T} is greater than or equal to the q_{R} updated in step 727, in step 731 the BS updates the target data rate q_{T} with the remaining q, value.

The found q_{T} value is a target data rate for the case where data is transmitted according to the priority given to the resource efficiency. The BS finds a sum, sum(q_{T}), of the q_{T} values found according to the priority, and determines sum(q_{T}) as a target data rate between the BS and the RS. That is, when the BS simultaneously transmits data to some of the MSs, the data rate is sum(q_{T}).

It should be noted that in addition to the scheduling method of steps 709 to 719 and the scheduling method of steps 721 to 731, there is another possible scheduling method of calculating the target data rate q_{T} based on a value obtained by dividing Σqᵢ by the number of MSs.

As can be appreciated from the foregoing description, the present invention can efficiently control a data rate between the BS and the RS using the channel information between the BS and the RS, and the channel information between the RS and the MS in the multi-hop communication system.

In addition, the present invention can solve the problem that since an ACK/NACK message needs to also pass through 2 hops to be normally transmitted, the BS having no information on the success/failure in the previous data transmission/reception transmits data to be transmitted in the next frame to the RS and the data is continuously buffered in the RS.

Further, the present invention can solve the problem that when the MS performs handover from the serving RS to the target RS, the data previously transmitted by the BS to the serving RS is useless and the BS must re-transmit the data to the target RS, thereby causing a decrease in the entire system performance.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for controlling a data rate by a Base Station (BS) in a multi-hop communication system in which a Relay Station (RS) located between the BS and a Mobile Station (MS) relays a signal exchanged between the BS and the MS, the method comprising the steps of:
receiving, from the RS, channel information of the MS and channel information of the RS;
calculating a target data rate to the RS using the channel information of the MS and the channel information of the RS;
generating data to be transmitted to the RS according to the calculated target data rate; and
transmitting the generated data to the RS.

2. The method of claim 1, wherein the channel information includes Channel Quality Index (CQI) information.

3. The method of claim 1, further comprising:
performing channel allocation and Modulation Coding Scheme (MCS) level decision according to the calculated data rate, and providing the resulting information to the RS.

4. The method of claim 1, wherein the calculating of a target data rate comprises:
determining if a data rate q_{R} for the RS is less than a sum Σqᵢ of a data rate of each individual MS belonging to the RS;
if the q_{R} is less than the Σqᵢ, determining if a simultaneous transmission at a data rate q, of each individual MS belonging to the RS is possible; and
if the simultaneous transmission is possible, taking as the target data rate q_{T} the lesser of the q_{R} and the Σqᵢ.

5. The method of claim 4, further comprising:
if the simultaneous transmission is not possible, determining if priority is given to a number of MSs; and
if priority is given to the number of MSs, determining as a target data rate a minimum value among remaining q, when the minimum value among the remaining data rate qᵢ of each individual MS belonging to the RS is greater than or equal to the data rate q_{R} for the RS.

6. The method of claim 4, further comprising:
if the simultaneous transmission is not possible, determining if priority is given to resource efficiency; and
if priority is given to the resource efficiency, determining as a target data rate a maximum value among remaining qᵢ when the maximum value among the remaining data rate qᵢ of each individual MS belonging to the RS is greater than or equal to the data rate q_{R} for the RS.

7. An apparatus for controlling a data rate in a Base Station (BS) of a multi-hop communication system in which a Relay Station (RS) located between the BS and a Mobile Station (MS) relays a signal exchanged between the BS and the MS, the apparatus comprising:
a channel information receiver for receiving, from the RS, channel information of the MS and channel information of the RS;
a data rate controller for calculating a target data rate to the RS using the channel information of the MS and the channel information of the RS;
an adaptive encoder for generating data to be transmitted to the RS according to the calculated target data rate; and
a transmitter for transmitting the generated data to the RS.

8. The apparatus of claim 7, wherein the channel information includes Channel Quality Index (CQI) information.

9. The apparatus of claim 7, further comprising:
a channel allocation and MCS level decision unit for performing channel allocation and Modulation Coding Scheme (MCS) level decision according to the calculated data rate.

10. The apparatus of claim 7, further comprising:
a reception buffer for buffering data received from an upper layer.

11. The apparatus of claim 7, wherein the data rate controller, determines if a data rate q_{R} for the RS is less than a sum Σqᵢ of a data rate of each individual MS belonging to the RS; if the q_{R} is less than the Σqᵢ, determines if simultaneous transmission at a data rate qᵢ of each individual MS belonging to the RS is possible; and if the simultaneous transmission is possible, takes as the target data rate q_{T} a minimum value between the q_{R} and the Σqᵢ.

12. The apparatus of claim 11, wherein the data rate controller, if the simultaneous transmission is not possible, determines if priority is given to a number of MSs; and if priority is given to the number of MSs, determines as a target data rate a minimum value among remaining qᵢ when the minimum value among the remaining data rate q, of each individual MS belonging to the RS is greater than or equal to the data rate q_{R} for the RS.

13. The apparatus of claim 11, wherein the data rate controller, if the simultaneous transmission is not possible, determines if priority is given to resource efficiency; and if priority is given to the resource efficiency, determines as a target data rate a maximum value among remaining qᵢ when the maximum value among the remaining data rate qᵢ of each individual MS belonging to the RS is greater than or equal to the data rate q_{R} for the RS.

14. A method for controlling a data rate by a Relay Station (RS) in a multi-hop communication system in which the RS located between a Base Station (BS) and a Mobile Station (MS) relays a signal exchanged between the BS and the MS, the method comprising the steps of:
determining if channel information is received from at least one MS; and
upon receipt of the channel information from the at least one MS, relaying the channel information of the at least one MS to the BS, and reporting the RS channel information to the BS.

15. The method of claim 14, wherein the channel information includes Channel Quality Index (CQI) information.

16. The method of claim 14, further comprising:
upon receipt of a signal from the BS, re-processing data according to an Modulation Coding Scheme (MCS) level determined by the BS;
relaying the re-processed data to the MS; and
calculating the RS queue length according to an amount of data transmitted to the MS.

17. The method of claim 16, further comprising:
reporting the calculated queue length to the BS.

18. An apparatus for controlling a data rate in a Relay Station (RS) of a multi-hop communication system in which the RS located between a Base Station (BS) and a Mobile Station (MS) relays a signal exchanged between the BS and the MS, the apparatus comprising:
a channel information receiver for receiving channel information from at least one MS;
a signal receiver for receiving data from the BS;
an adaptive encoder for generating data to be transmitted to the at least one MS;
a physical layer data transmitter for transmitting the generated data to the MSs;
a queue length calculator for calculating a queue length based on an amount of data to be transmitted to the at least one MS; and
a feedback information transmission unit for transmitting, to the BS, channel information of the RS, channel information of the at least one MS.

19. The apparatus of claim 18, wherein the channel information includes Channel Quality Index (CQI) information.

20. The apparatus of claim 18, wherein the feedback information transmission unit reports the calculated queue length information to the BS.
